(19) United States
(12) Patent Application Publication
(10) Pub. No.: US 2018/0114173 A1
(43) Pub. Date: Apr. 26, 2018

(54) COGNITIVE SERVICE REQUEST DISPATCHING

(71) Applicant: International Business Machines Corporation, Armonk, NY (US)

(72) Inventors: Jeanette L. Blomberg, Portola Valley, CA (US); Robert M. Delmonico, White Plains, NY (US); Yixin Diao, White Plains, NY (US); Karin Murthy, Danbury, CT (US); Larisa Shwartz, Scarsdale, NY (US)

(21) Appl. No.: 15/298,384

(22) Filed: Oct. 20, 2016

(51) Int. Cl. G06Q 10/06; G06F 7/02; G06N 99/00

(52) U.S. Cl. CPC G06Q 10/063112; G06N 99/005; G06F 7/023; G06Q 10/06395

(57) ABSTRACT

A cognitive based service request dispatching system quantifies cognitive dependency of a service request and assigns the service request to maximize a value of cognitive match. A set of metrics comprising service quality index, cognitive capability score, cognitive dependency weight, and cognitive matching score are determined to quantify cognitive dependency of a service request and cognitive based assignment and dispatching of the service request.

### FIELD

The present application relates generally to computers and computer applications, and more particularly to cognitive service request dispatching.

### BACKGROUND

This disclosure addresses the problem of improving the service delivery quality and productivity based on cognitive enhanced dispatching decisions. Current service delivery request dispatching decision is based on service agent's skills and availability, as well as the service level objectives of the request to be completed. However, they do not consider the cognitive information of the service agents. Other existing methods may use gaming to assess the cognitive aptitudes of the service agents. However, those methods do not consider the dependency between work quality and sentiment state which may be different for different service types.

### BRIEF SUMMARY

A method and system of automatically learning and dispatching a service request may be provided. The method, in one aspect, may include receiving a plurality of service requests entered via a user interface associated with an information technology system, the service requests requesting a service on the information technology system. The method may also include receiving a list of service agents available to address the service requests. The method may further include monitoring a cognitive state of each of the service agents. The method may also include determining a cognitive capability score for said each of the service agents based on the monitored cognitive state. The method may also include assigning the service requests to the service agents randomly. The method may further include measuring quality of the service requests that are completed. The method may also include determining a service quality index based on the measured quality of the service requests for each of the service requests. The method may also include correlating the cognitive capability score and the service quality index. The method may further include generating a cognitive dependency model comprising cognitive dependency weight associated with each of the service requests, the cognitive dependency weight computed based on the correlated cognitive capability score and service quality index.

A method, in another aspect, may include automatically dispatching service requests. The method that automatically dispatches service requests, in one aspect, may include receiving via a user interface associated with an information technology system, incoming service requests requesting for service on the information technology system. The method may further include computing a cognitive dependency weight associated with each of the incoming service requests based on a cognitive dependency model. The method may also include monitoring cognitive state of service agents available to address the service request. The method may further include computing a cognitive capability score for each of the service agents based on the monitoring. The method may also include computing a cognitive matching score associated with a pair of a service request and a service agent, for all pairs in the service requests and the service agents, as a function of the cognitive dependency weight and the cognitive capability score. The method may further include assigning the service requests to the service agents with highest cognitive matching score.

A system of automatically dispatching service requests, in one aspect, may include at least one hardware processor coupled to a memory device. The at least one hardware processor may receive via a user interface associated with an information technology system, incoming service requests requesting for service on the information technology system. The at least one hardware processor may compute a cognitive dependency weight associated with each of the incoming service requests based on a cognitive dependency model stored in the memory device. The at least one hardware processor may monitor cognitive state of service agents available to address the service request. The at least one hardware processor may compute a cognitive capability score for each of the service agents based on the monitoring. The at least one hardware processor may compute a cognitive matching score associated with a pair of a service request and a service agent, for all pairs in the service requests and the service agents, as a function of the cognitive dependency weight and the cognitive capability score. The at least one hardware processor may compute dispatching the service requests to the service agents with highest cognitive matching score.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating system architecture in one embodiment of the present disclosure.

FIG. 2 is a diagram illustrating computing of a cognitive dependency weight in one embodiment of the present disclosure.

FIG. 3 is a flow diagram illustrating a method of learning a cognitive dependency model for cognitive dispatching in one embodiment of the present disclosure.

FIG. 4 is a flow diagram illustrating cognitive dispatching of service requests in one embodiment of the present disclosure.

FIG. 5 illustrates a schematic of an example computer or processing system that may implement a cognitive service request learning and dispatching system in one embodiment of the present disclosure.

### DETAILED DESCRIPTION

A system, method and technique may be presented that dispatch the service request to a service agent based on the cognitive state (also referred to as sentiment state) of the service agents and the dependency between work quality and sentiment state. A cognitive based service request dispatching system and method may quantify the cognitive dependency of the service request and assign the service request to maximize the value of cognitive match. A cognitive based service request dispatching system and method, in one aspect, improve the service request resolution quality through a systematic approach, for example, by defining a set of metrics such as service quality index, cognitive capability score, cognitive dependency weight, cognitive matching score, to assist quantification, and for example, implementing a greedy algorithm to guide the cognitive based assignment.

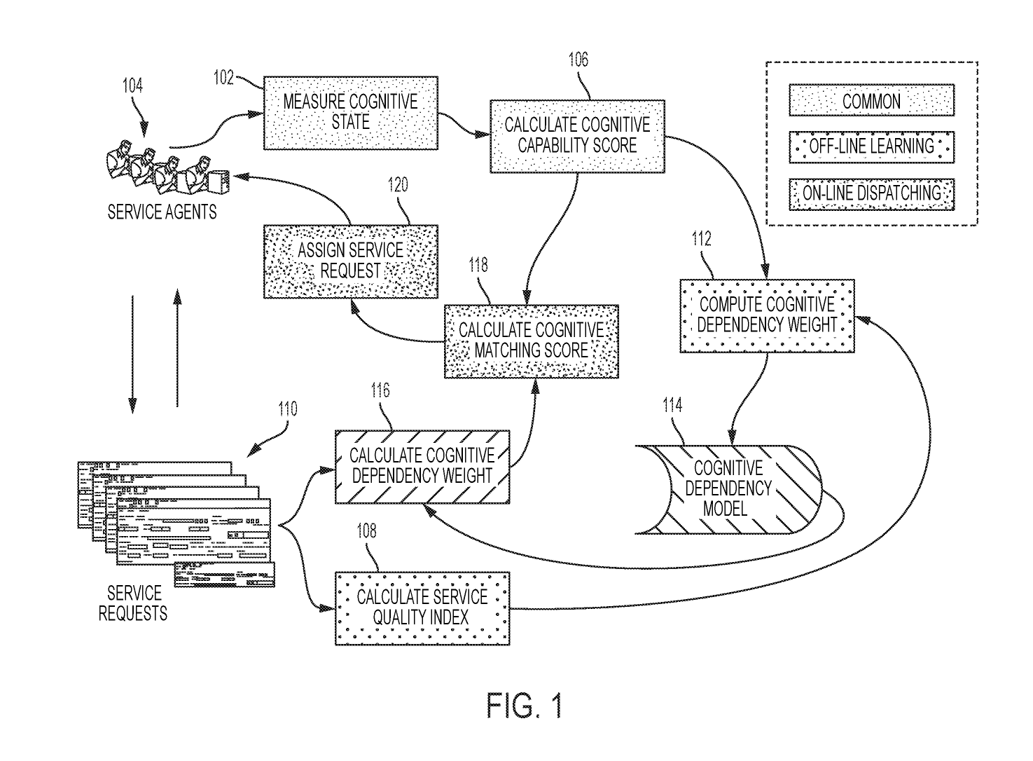

FIG. 1 is a diagram illustrating system architecture in one embodiment of the present disclosure. The components shown in FIG. 1 may run or execute on one or more hardware processors. A system in one embodiment of the present disclosure may define the cognitive or sentiment state of a person (e.g., a service agent that processes service requests) through emotional attributes and action attributes. Examples of emotional attributes include but are not limited to pleasant, happy, stressed, and bored. Examples of action attributes include but are not limited to alert and calm. The cognitive state can be measured through monitoring the service agent's behavior and quantified through a numerical composite score to indicate its state as being positive, negative, or neutral. For example, a cognitive state measurement component 102 may monitor and measure the service agent's 104 behavior. Service agent's behavior can be monitored and measured, for example, by observing the agent's writing, talking, and/or acting. A calculate cognitive capability score component 106 may compute a numerical composite score based on monitoring and measuring. An example of a numerical composite score may be a number ranging from −5 to 5. This score, also referred to in the present disclosure as a cognitive capability score, defines the cognitive state of an agent. The score in one embodiment may be a numerical range. For example, a score less than −1 is considered negative, a score larger than 1 is considered positive, and a score between −1 and 1 is considered neutral.

The source that is monitored to measure the agent's behavior may include but are not limited to documents the agent has recently accessed such as closed service request resolution summary, instant messaging communication, body temperature, warm-up quiz/game test scores. A behavior sentimental analysis may be performed based on the service agent's recent access, for example, to those documents. Formally, let the cognitive capability score for the n-th agent be C_n which, in a more general terms, can have multiple (M) features: C_n=[c_n1, c_n2, . . . , c_nM].

The system in one embodiment also defines the work quality of a service agent through measuring the work that the agent has completed. For example, a calculate service quality index component 108 may perform this function. The work quality of a service agent definition may include the service time, for example, as compared to the average service time for performing similar work, and the service quality, e.g., whether the work is completed successfully or rework is needed.

In one embodiment, the service quality of a completed service request is a function of several quality parameters. Formally, let the quality parameter along the j-th dimension be d_j. For example, for the service time dimension, the quality can be represented by comparing the actual service time with the average service time from the same service request class: d_j=t−t_avg.

In one embodiment, the rework dimension can be based on a code that specifies whether the work is completed or transferred, e.g., the closure code: d_j=[completed, transferred]. Formally, let the service quality index be Q_i for the i-th service request. The service quality index can be computed as a function of, e.g., the product of the each quality parameter dimension: Q_i=d_1 d_2 . . . d_J, for J dimensions.

The cognitive service request dispatching system may include a plurality of phases: offline learning and online dispatching. Offline learning may include assigning different service requests 110 to the service agent 104; monitoring the cognitive state of the service agent at 102 and 106; measuring the quality of the completed service requests at 108; correlating the cognitive state and the work quality at 112, and deriving a numerical score (e.g., from 0 to 1) indicating whether the service request is cognitive dependent or cognitive independent, for example, building a cognitive dependency model at 114.

Online dispatching may include profiling an incoming service request as cognitive dependent or cognitive independent at 116, for example, based on the cognitive dependency model at 114; determining the current cognitive state of the service agents at 118; and assigning the service request at 120 or distributing the service request to the service agent determined to maximize the work quality.

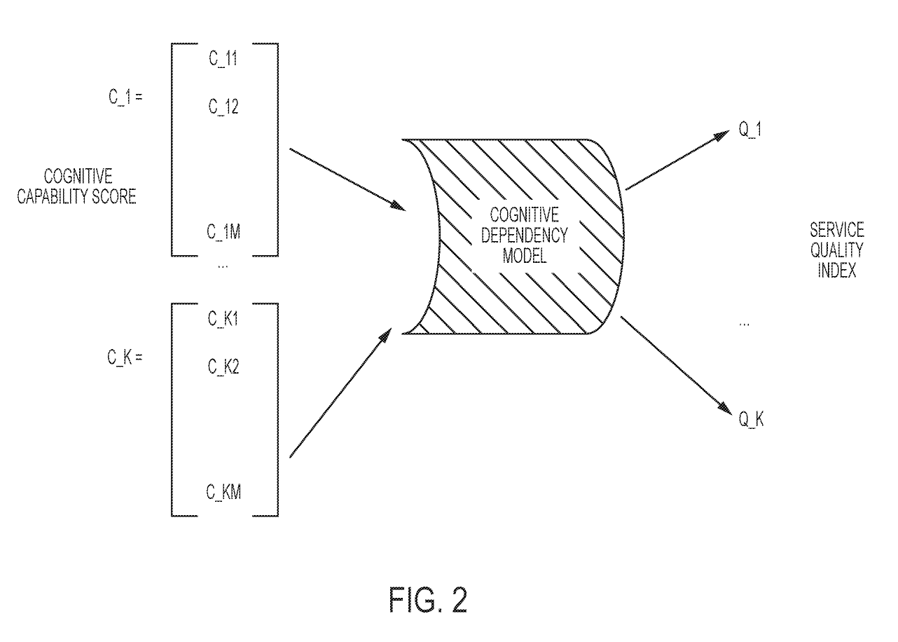

Compute cognitive dependency weight component 112 may determine cognitive dependency weight. For a set of K service requests within the same characterization or classification, each service request is assigned with a service agent. Each service request is assigned a different service agent. Because different service agent may have different cognitive capability (left part of the chart in FIG. 2), and different service request may be completed with different service quality (right part of the chart in FIG. 2), the dependency weight can be learned to characterize how each cognitive capability affects the service quality. FIG. 2 is a diagram illustrating computing of a cognitive dependency weight in one embodiment of the present disclosure. In one embodiment, the cognitive dependency weight is defined as W=[w_1, w_2, . . . , w_M], where w_m=corrcoef ([c_m, c_2m, . . . , c_Km], [Q_1, Q_2, . . . , Q_K]), in the range of [0, 1]. W is a vector and w_m is its component. That is, m=1, 2, . . . , M for M components of w_1, w_2, . . . , w_M. “corrcoef” is correlation coefficient. Here, a cognitive capability score for the k-th service is C_k, where k, k=1, . . . , K for K services. c_km represents a cognitive capability score for k-th service's m-th feature. In one embodiment, the cognitive capability score is measured and computed through experiments that are independent of the service requests being dispatched and performed. For example, the cognitive capability of “attention to detail” can be evaluated through a set of aptitude tests. Other methods may be employed to measure cognitive capability score. m=1, . . . , M for M number of cognitive features or attributes, indicating the m-th cognitive capability feature. w_m represents a dependency weight of a service quality on a cognitive feature. k=1, 2, . . . , K indicating the k-th service requests, which are used as the training data set to compute the cognitive dependency weight. c_km indicates the cognitive capability score for the k-th service agent (or k-th service request since one service agent is assigned to one service request) and the m-th cognitive capability feature. Q_k indicates the service quality index for the k-th service request. w_m indicates the m-th cognitive dependency weight.

In one embodiment, the cognitive dependency weight is computed through correlation coefficient, which quantifies the statistical relationships between the cognitive capability scores (independent variables) and the service quality index (dependent variable). In one aspect, there are M cognitive dependency weights, corresponding to M cognitive capability features. Cognitive dependency weight represents the extent a quality depends on a cognitive attribute. In one embodiment, the following notations are used: m=1, 2, . . . , M indicates the m-th cognitive capability feature; k=1, 2, . . . , K indicates the k-th service requests, which are used as the training data set to compute the cognitive dependency weight; c_km indicates the cognitive capability score for the k-th service agent (or k-th service request since one service agent is assigned to one service request) and the m-th cognitive capability feature; q_k indicates the service quality index for the k-th service request; w_m indicates the m-th cognitive dependency weight.

A cognitive matching score, for example, computed at calculate cognitive matching score component in FIG. 1 at 118, may include performing the following functions. Given a service request k with cognitive dependency weight W_k=[w_k1, w_k2, . . . , w_kM] for all features 1 to M, and a service agent n with cognitive capability score C_n=[c_n1, c_n2, . . . , c_nM], where M represents a number of cognitive attributes or features, the system in one embodiment defines a cognitive matching score using the dot product S_kn=sum (W_k .*C_n).

Given a set of service requests (K), the system in one embodiment uses the following greedy algorithm to maximize the cognitive matching and thus service quality. That is, max ΣΣ S_kn.

Greedy algorithm:
1. Calculate S_kn for all K service requests and N service agents;
2. Find argmax (S_kn) and assign the service request;
3. K=K−1, N=N−1;
4. Go to step 1 until K=0 or N=0.

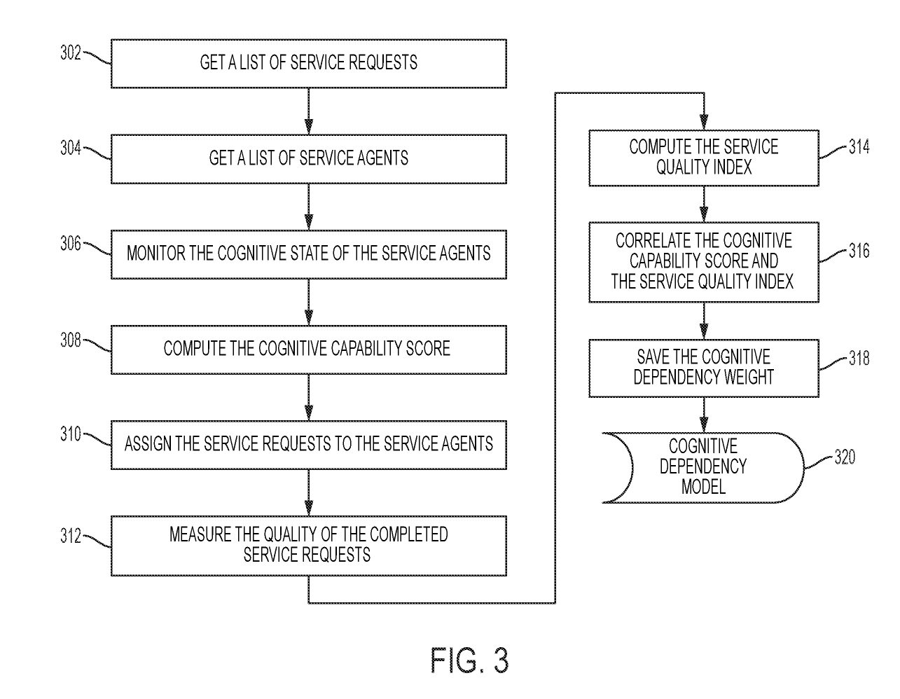

FIG. 3 is a flow diagram illustrating a method of learning a cognitive dependency model for cognitive dispatching in one embodiment of the present disclosure. The method shown in FIG. 3 may be performed during off-line learning. At 302, a list of service requests is obtained. A service request, for example, may be a request to perform a service in information technology (IT) systems, for example, solving a computer error or problem occurring in a computer system.

At 304, a list of service agents is obtained. Service agents may be computer administrators or the like that address problems in an IT system. At 306, cognitive states of the service agents are monitored, for example, based on their activities and documents they access. For example, based on rules and/or analytics, a cognitive state may be measured. The cognitive state and thus the cognitive capability score may be measured and computed through experiments that are independent of the service requests being dispatched and performed. For example, the cognitive capability of “attention to detail” can be evaluated through a set of aptitude tests.

At 308, cognitive capability score is computed, for example, as described above with reference to FIG. 1, and quantifies monitored attributes or features. A cognitive capability score may be computed per service agent.

At 310, the service requests are assigned to the service agents. In one embodiment, an initial assignment may be based on random assignment. For instance the service requests are assigned to the service agents randomly here, for example, to have more variability in modeling data for building a cognitive dependency model.

At 312, the quality of the completed service requests is measured. The quality measurement, for example, may measure the amount of time it took to complete the request or service time and compare it to a standard or average service time, and a closure code such as whether the work performed for addressing the service request was completed or transferred. Based on the measurement, at 314, the service quality index is computed. A service quality index may be computed as a function of a plurality of quality parameters, for example, service time dimension and rework dimension. A service quality index may be computed per service request.

At 316, the cognitive capability score and the service quality index are correlated. For instance, cognitive dependency weights are computed via correlation coefficients. At 318, cognitive dependency weight computed based on the correlation at 316 is saved, for example, in a cognitive dependency model 320. By way of an example, consider M=3 cognitive features and a set of K=10 service requests in order to evaluate and compute the cognitive dependency weights W=[w_1, w_2, w_3], indicating how each of the 3 cognitive features affects the quality of the completed service requests (Q_1, Q_2, . . . , Q_10). In order to compute the first cognitive dependency weight w_1, the method constructs two vectors: c_1=[c_1_1, c_2_1, . . . , c_10_1] indicating the cognitive capability score for the first cognitive feature (e.g., attention to detail) and Q=[Q_1, Q_2, . . . , Q_10] indicating the quality of the completed service requests. In this example, the cognitive dependency weight w_1 is computed through the correlation coefficient formula: cov(c_1, Q) /(std(c_1)*std(Q), where coy defines the covariance of c_1 and Q and std defines the standard deviation of c_1 and Q, respectively. Service quality Q described above refers to the model computing work for one service request type, for example, training and use of one service request class as an example, where W is used to denote the service request type's corresponding dependency model. For instance, Q includes service requests that share the same characteristics, for instance, categorized into a service type. For example, “CPU utilization high” may be one type of the service request, where the CPU utilization could be 95% in one service request and 90% in another. As another example, “password reset” may be a different type of the service request. For instance, service requests and corresponding service quality indices may be classified into a class or type for determining dependency weight for the type.

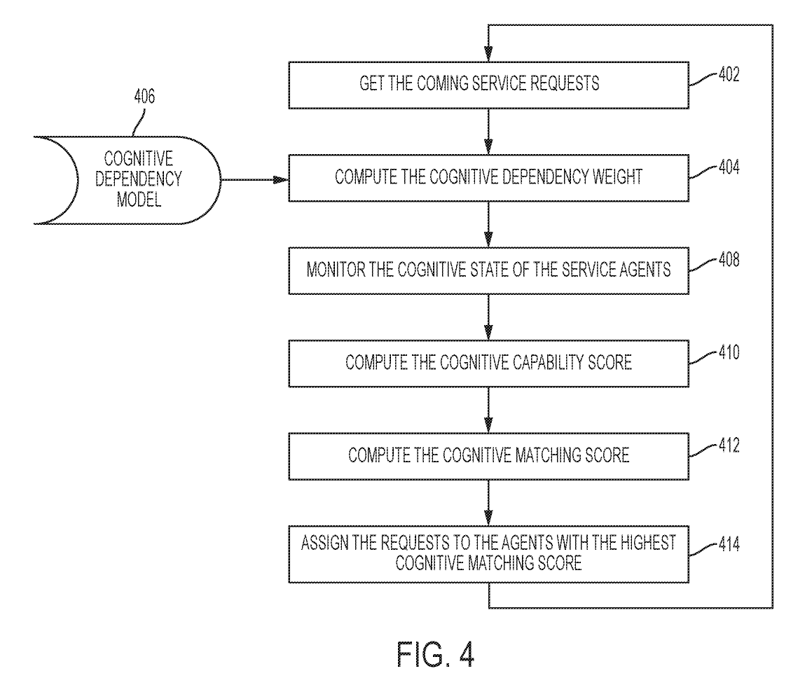

FIG. 4 is a flow diagram illustrating cognitive dispatching of service requests in one embodiment of the present disclosure. The method is FIG. 4 may be performed during on-line dispatching. At 402, an incoming service request is received. At 404, a cognitive dependency weight is computed for the incoming service request based on the cognitive dependency model 406, for example, built according to the method shown in FIG. 3. For instance, the cognitive dependency weight may be computed through correlation coefficient using the cognitive dependency model 406. The cognitive dependency model that is generated includes all cognitive dependency weights for all service request types, for example, a cognitive dependency weight per feature per service request type. Thus, each service request type may have one or more associated cognitive dependency weights. Given a new or incoming service request, the method may determine which service request type the incoming service request belongs to, then look up and find the corresponding set of the cognitive dependency weights in the cognitive dependency model.

At 408, the cognitive states of the service agents are monitored. At 410, cognitive scores are computed corresponding to the service agents, respectively, for example, a cognitive score per service agent, for example, as described above with reference to FIG. 1.

At 412, a cognitive matching score is computed for the incoming service request, for example, as described above with reference to the ‘calculate cognitive matching score component’ in FIG. 1 at 118. At 414, the incoming request is assigned to the service agent with the highest cognitive matching score. The method may repeat for the next incoming request, or set of incoming requests.

Examples of other cognitive attributes may include but are not limited to cognitive/neural wiring attributes including attention to detail, ability to interconnect problems and changes, pattern recognition which may include the ability to determine patterns from individual instances and recognize the problem at hand is similar to another problem, and cognitive/emotive attributes including ability to handle pressure sensitive situation, and persistence.

Cognitive aware classification and dispatching in one embodiment of the present disclosure may include service request classification, service agent profiling and dispatching. In service request classification, for example, in addition to skill based classification (e.g., activity, sub-activity), each incoming service request is classified based on a plurality of cognitive attributes (e.g., above described cognitive/neural wiring and cognitive/emotive attributes) using scores such as low, medium, and high to indicate its dependency. This may be done based on the cognitive dependency weight W=[w_1, w_2, . . . , w_M] for M cognitive attributes. For each cognitive attribute m, the numerical value of w_m can be grouped into low, medium, high to simplify the model operation. The value for low may range between 0 and 0.3, the value for medium may range between 0.3 and 0.6, and the value for high may range from 0.6 to 1. In service agent profiling, each service agent is profiled or assigned attributes based on the plurality of cognitive attributes (e.g., above described cognitive/neural wiring and cognitive/emotive attributes). In dispatching, given at least two service agents that are skill qualified, the service request will be dispatched to the service agents with the better cognitive match. The cognitive match is determined, for example, by jointly considering all of the plurality of cognitive attributes, for example, the cognitive/neural wiring attributes and the cognitive/emotive attributes, which are not independent.

The following illustrates an example use case. A service request classification may classify a service request into class 1. Class 1 may have the following attributes: Attention to detail=Medium; Ability to see the interconnection=Low; Ability for pattern recognition=Medium; Ability to stay calm under pressure=High (e.g., because the service request has a short deadline);

Persistence=Low. Service agents' cognitive states may be monitored, measured, and the following attributes may be assigned. Service agent A: Attention to detail=High ->Low;

Ability to see the interconnection=High ->Low; Ability for pattern recognition=High ->Low; Ability to stay calm under pressure=Low; Persistence=High. Service agent B: Attention to detail=Medium ->Medium; Ability to see the interconnection=Low ->Low; Ability for pattern recognition=High ->High; Ability to stay calm under pressure=High; Persistence=Low. Based on the above classification, a dispatching decision is made to assign service request 1 to service agent B.

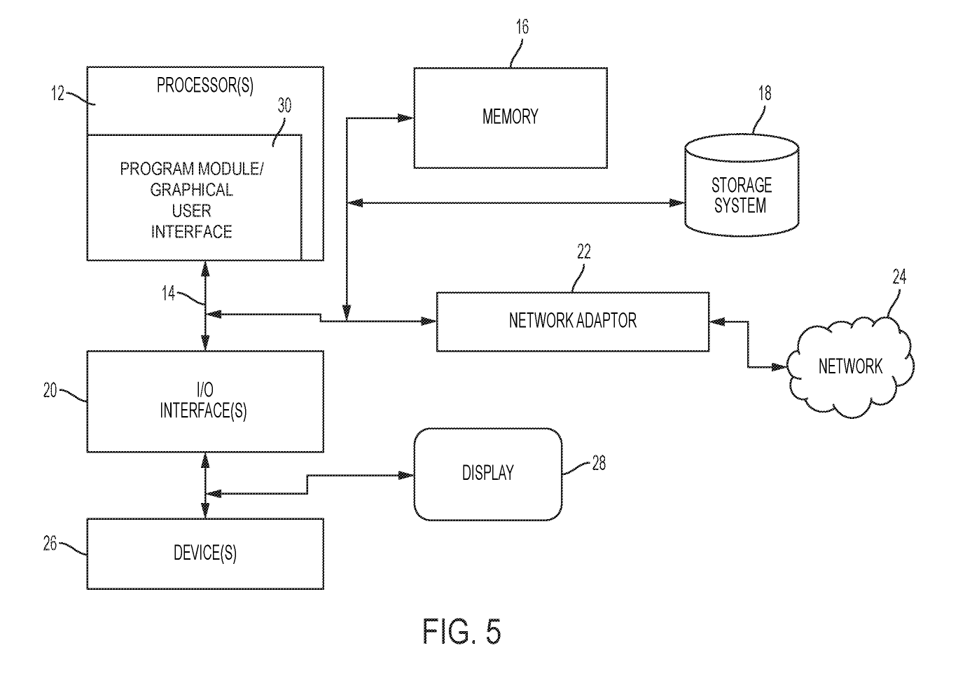

FIG. 5 illustrates a schematic of an example computer or processing system that may implement a cognitive service request learning and dispatching system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network.

In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of automatically learning and dispatching a service request, the method performed by at least one hardware processor, comprising:
receiving a plurality of service requests entered via a user interface associated with an information technology system, the service requests requesting a service on the information technology system, the service requests comprising at least a request to address a problem associated with a central processing unit (CPU) utilization in the information technology system and at least a request to solve a problem associated with a password reset in the information technology system, wherein the service requests are classified into different types;
receiving a list of service agents available to address the service requests;
monitoring a cognitive state of each of the service agents;
determining a cognitive capability score for said each of the service agents based on the monitored cognitive state;
assigning the service requests to the service agents randomly;
measuring quality of the service requests that are completed;
determining a service quality index based on the measured quality of the service requests for each of the service requests;
correlating the cognitive capability score and the service quality index; and
generating a cognitive dependency model comprising cognitive dependency weight associated with each of the service requests, the cognitive dependency weight computed based on the correlated cognitive capability score and service quality index, wherein the cognitive dependency weight is defined as W=[w_1, w_2, . . . , w_M], wherein w_m=corrcoef [c_1m, c_2m, . . . , c_Km], [Q_1, Q_2, . . . , Q_K]) where m=1, 2, . . . , M indicating m-th cognitive capability feature, where k=1, 2, . . . , K indicates k-th service request, wherein c_km indicates the cognitive capability score for k-th service request, wherein Q_k indicates the service quality index for k-th service request, wherein w_m indicates m-th cognitive dependency weight, the cognitive dependency weight indicating for a corresponding service request type, how each of cognitive capability features affects a quality of completed service request of the corresponding service request type, wherein the cognitive capability features comprise emotional attributes and action attributes, the cognitive dependency weight determined as a covariance of the cognitive capability score and the service quality index divided by a product of a standard deviation of the cognitive capability score and a standard deviation of the service quality index.

2. The method of claim 1, further comprising:
receiving via the user interface an incoming service request requesting for service on the information technology system;
computing a cognitive dependency weight associated with the incoming service request based on the cognitive dependency model;
computing a cognitive matching score associated with a pair comprising the service request and a service agent in the service agents, as a function of the cognitive dependency weight and the cognitive capability score associated with the service agent, for each of all pairs of the service request and service agent in the service agents; and
assigning the service request to the service agent in the pair with highest cognitive matching score.

3. The method of claim 2, further comprising:
dispatching, via a computer network, the service request to the assigned service agent assigned based on the highest cognitive matching score.

4. The method of claim 2, wherein the cognitive dependency weight comprises a vector of weights associated with cognitive attributes.

5. The method of claim 4, wherein the cognitive capability score comprises a vector of cognitive attribute measures and the cognitive matching score is computed as a dot product of the cognitive dependency weight and the cognitive capability score.

6. The method of claim 1, wherein the cognitive capability score comprises a vector of cognitive attribute measures.

7. The method of claim 1, wherein the service quality index is determined based on a plurality of service qualities.

8. A computer readable storage medium storing a program of instructions executable by a machine to perform a method of automatically dispatching service requests, the method comprising:
receiving via a user interface associated with an information technology system, incoming service requests requesting for service on the information technology system, the service requests comprising at least a request to address a problem associated with a central processing unit (CPU) utilization in the information technology system and at least a request to solve a problem associated with a password reset in the information technology system, wherein the service requests are classified into different types;
computing a cognitive dependency weight associated with each of the incoming service requests based on a cognitive dependency model, wherein the cognitive dependency weight is defined as W=[w_1, w_2, . . . , w M], wherein w_m=corrcoef ([c_1m, c_2m, . . . , c_Km], [Q_, Q_2, . . . , Q_K]) where m=1, 2, . . . , M indicating m-th cognitive capability feature, where k =1, 2, . . . , K indicates k-th service request, wherein c_km indicates the cognitive capability score for k-th service request, wherein q_k indicates the service quality index for k-th service request, wherein w_m indicates m-th cognitive dependency weight, the cognitive dependency weight indicating for a corresponding service request type, how each of cognitive capability features affects a quality of completed service request of the corresponding service request type,
monitoring cognitive state of service agents available to address the service request;
computing a cognitive capability score for each of the service agents based on the monitoring;
computing a cognitive matching score associated with a pair of a service request and a service agent, for all pairs in the service requests and the service agents, as a function of the cognitive dependency weight and the cognitive capability score; and
assigning the service requests to the service agents with highest cognitive matching score.

9. The computer readable storage medium of claim 8, wherein the cognitive dependency model is generated by:
measuring quality of the service requests that are completed;
determining a service quality index based on the measured quality of the service requests for each of the service requests;
correlating the cognitive capability score and the service quality index; and
generating the cognitive dependency model comprising cognitive dependency weight associated with each type of the service requests, the cognitive dependency weight computed based on the correlated cognitive capability score and service quality index, the cognitive dependency weight determined as a covariance of the cognitive capability score and the service quality index divided by a product of a standard deviation of the cognitive capability score and a standard deviation of the service quality index.

10. The computer readable storage medium of claim 9, further comprising:
dispatching the service request to the assigned service agent via a computer network.

11. The computer readable storage medium of claim 9, wherein the cognitive dependency weight comprises a vector of weights associated with cognitive attributes.

12. The computer readable storage medium of claim 11, wherein the cognitive capability score comprises a vector of cognitive attribute measures and the cognitive matching score is computed as a dot product of the cognitive dependency weight and the cognitive capability score.

13. The computer readable storage medium of claim 9, wherein the service quality index is determined based on a plurality of service qualities.

14. The computer readable storage medium of claim 13, wherein the service qualities comprise service time and request closure information.

15. A system of automatically dispatching service requests, comprising:
at least one hardware processor coupled to a memory device;
the at least one hardware processor receiving via a user interface associated with an information technology system, incoming service requests requesting for service on the information technology system, the service requests comprising at least a request to address a problem associated with a central processing unit (CPU) utilization in the information technology system and at least a request to solve a problem associated with a password reset in the information technology system, wherein the service requests are classified into different types;
the at least one hardware processor computing a cognitive dependency weight associated with each of the incoming service requests based on a cognitive dependency model stored in the memory device, wherein the cognitive dependency weight is defined as W=[w_1, w_2, . . . , w_M], wherein w_m=corrcoef ([c_1m, c_2m, . . . , c_Km], [Q_2, . . . , Q_K]) where m=1, 2, . . . , M indicating m-th cognitive capability feature, where k=1, 2, . . . , K indicates k-th service request, wherein c_km indicates the cognitive capability score for k-th service request, wherein q_k indicates the service quality index for k-th service request, wherein w_m indicates m-th cognitive dependency weight, the cognitive dependency weight indicating for a corresponding service request type, how each of cognitive capability features affects a quality of completed service request of the corresponding service request type,;
the at least one hardware processor monitoring cognitive state of service agents available to address the service request;
the at least one hardware processor computing a cognitive capability score for each of the service agents based on the monitoring;
the at least one hardware processor computing a cognitive matching score associated with a pair of a service request and a service agent, for all pairs in the service requests and the service agents, as a function of the cognitive dependency weight and the cognitive capability score; and
the at least one hardware processor computing dispatching the service requests to the service agents with highest cognitive matching score.

16. The system of claim 15, wherein the cognitive dependency model is generated by:
measuring quality of the service requests that are completed;
determining a service quality index based on the measured quality of the service requests for each of the service requests;
correlating the cognitive capability score and the service quality index; and
generating the cognitive dependency model comprising cognitive dependency weight associated with each type of the service requests, the cognitive dependency weight computed based on the correlated cognitive capability score and service quality index, the cognitive dependency weight determined as a covariance of the cognitive capability score and the service quality index divided by a product of a standard deviation of the cognitive capability score and a standard deviation of the service quality index.

17. The system of claim 16, wherein the cognitive dependency weight comprises a vector of weights associated with cognitive attributes.

18. The system of claim 17, wherein the cognitive capability score comprises a vector of cognitive attribute measures and the cognitive matching score is computed as a dot product of the cognitive dependency weight and the cognitive capability score.

19. The system of claim 17, wherein the service quality index is determined based on a plurality of service qualities.

20. The system of claim 19, wherein the service qualities comprise service time and request closure information.
